(19) United States
(12) Patent Application Publication
(10) Pub. No.: US 2002/0100658 A1
(43) Pub. Date: Aug. 1, 2002

(54) Transmission control system

(76) Inventors: Timothy D. Williams, Gilbertville, IA (US); Paul A. Boyer, Marshall, IL (US)

Correspondence Address: MICHAEL BEST & FRIEDRICH LLP, 3773 CORPORATE PARKWAY, SUITE 360, CENTER VALLEY, PA, 18034-8217, US

(21) Appl. No.: 09/772,491

(22) Filed: Jan. 30, 2001

(51) Int. Cl. B60K 41/26; F16H 59/36

(52) U.S. Cl. 192/220; 74/336 R

(57) ABSTRACT

A system for controlling gear shifting of an industrial vehicle having a transmission operable between at least two gear ratios by actuation of a transmission actuator. The system generally comprises a sensor configured to monitor one or more vehicle parameters and a controller associated with the sensor and the transmission actuator. The controller is configured to prevent actuation of the transmission actuator unless one or more vehicle parameters is in a predetermined condition.

### BACKGROUND

The present invention relates to industrial vehicles, and more particularly to devices for controlling the transmission of such vehicles.

Many industrial vehicles include a tractor which is mobilized either by separate wheels or by tracks driven by wheel trains. In both cases, the wheels of the tractor are typically rotated by a drive system that includes one or more motors, each having a shaft connected to driven wheels by means of a transmission mechanism. Generally, such transmission mechanisms are adjustable between at least two operating conditions, for example, a “high speed/low torque”condition and a “low speed/high torque” condition, and may operate at three or more states to inversely vary the torque and speed.

In many industrial vehicles, the transmission mechanisms are gear trains that are adjustable between different operating states or “gear ratios” by means of one or more actuators, for example, hydraulic clutches. The clutches function to alternatively engage with and disengage from certain gear train components in order to change gear ratios, and thus vary the speed and torque applied to the driven wheels. However, due to the mass of these vehicles, changing between gear ratios when the vehicle is moving above a given speed may damage the transmissions. As such, the operating manuals generally instruct the operator to stop the vehicle prior to changing of the gear ratio, which instruction may or may not be followed.

### SUMMARY

The present invention provides a system for controlling gear shifting of an industrial vehicle having a transmission operable between at least two gear ratios by actuation of a transmission actuator in response to a gear ratio command. The system generally comprises a sensor configured to monitor one or more vehicle parameters and a controller associated with the sensor, the gear ratio command and the transmission actuator. The controller is configured to prevent actuation of the transmission actuator unless one or more vehicle parameters is in a predetermined condition. In a first embodiment, the sensor monitors the speed of the vehicle and actuation of the transmission actuator is prevented unless the vehicle speed is less than or equal to a limit value. In a second preferred embodiment, the sensor monitors whether the vehicle drive system is in neutral or in drive and actuation of the transmission actuator is prevented unless the drive system is in neutral. By preventing actuation of the transmission actuator, the controller helps reduce the risk of damage to the transmission.

### BRIEF DESCRIPTION OF THE DRAWINGS

FIG. 1 is an isometric view of an illustrative industrial vehicle.

FIG. 2 is a bottom plan view illustrating the drive system of the vehicle of FIG. 1.

FIG. 3 is a system diagram of a first embodiment of the transmission control system of the present invention.

FIG. 4 is a flow diagram of a first control sequence of the controller of the first embodiment.

FIG. 5 is a flow diagram of a second control sequence of the controller of the first embodiment.

FIG. 6 is a system diagram of a second embodiment of the transmission control system of the present invention.

FIG. 7 is a flow diagram of a first control sequence of the controller of the second embodiment.

### DETAILED DESCRIPTION OF THE PREFERRED EMBODIMENTS

The preferred embodiments of the present invention will be described with reference to the drawing figures with like numerals representing like elements throughout. Certain terminology, for example, “right”, “left”, “forward” and “reverse”, is used in the following description for clarity of relational description only and is not intended to be limiting.

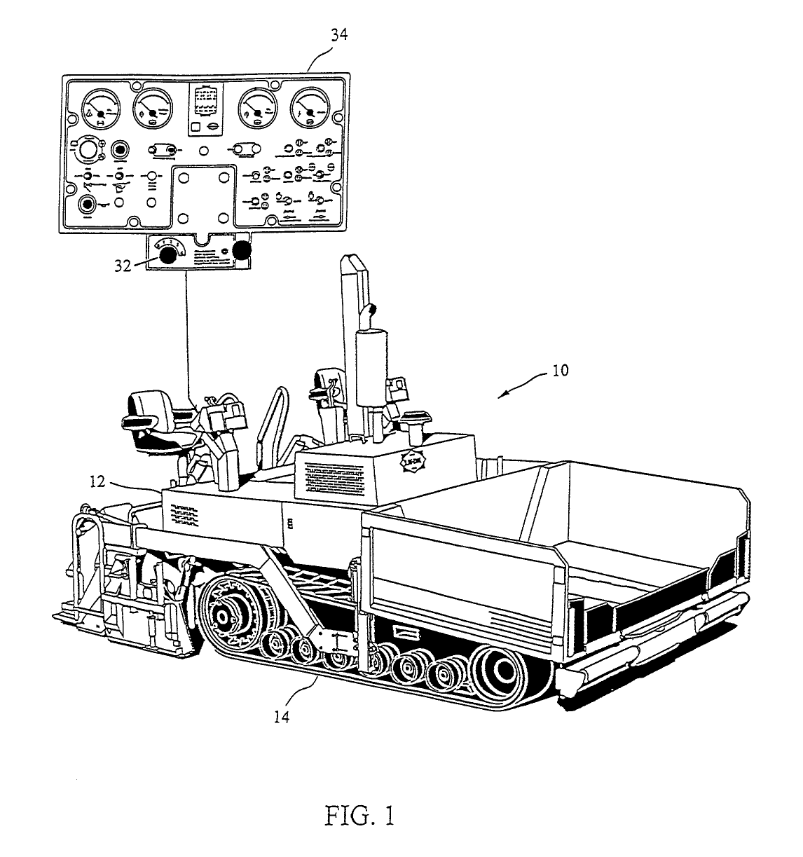

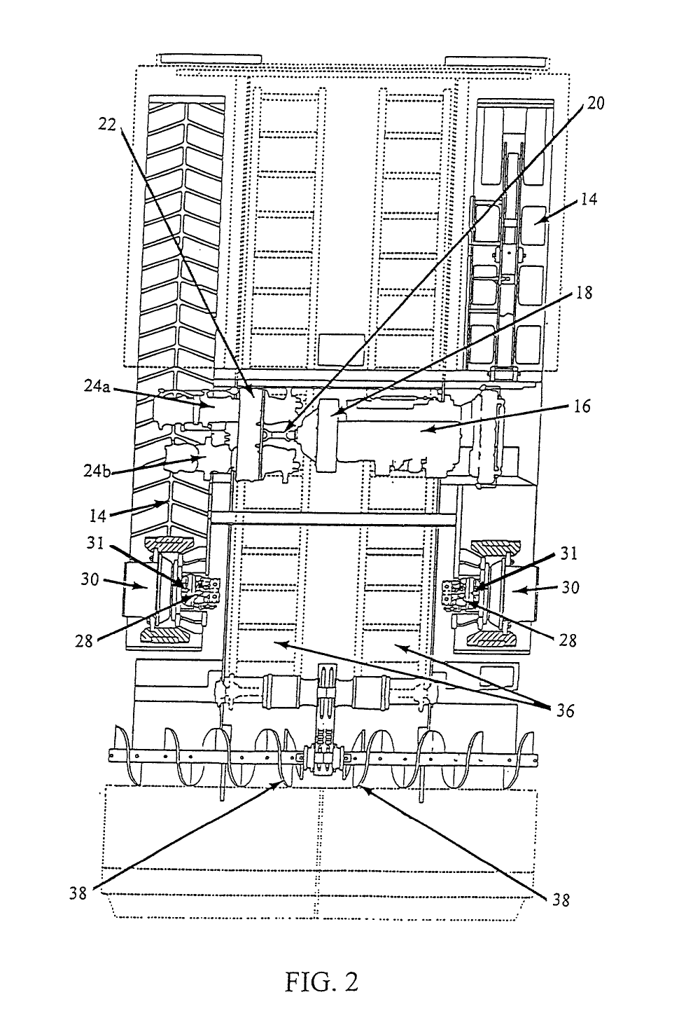

Referring to FIGS. 1 and 2, an illustrative industrial vehicle, a paver 10, is shown. The illustrated paver 10 includes a tractor 12, mounted on opposed drive tracks 14, and various conveyors 36 and augers 38. Power is provided by an engine 16 and delivered through a PTO clutch 18 and drive shaft 20 to a pump drive box 22. Traction drive power is hydrostatically transmitted from independent left-hand and right-hand traction drive pumps 24a, 24b to left-hand and right-hand drive units 26a, 26b located inside the respective drive track assemblies 14. In vehicles having separate wheels and a steering wheel, as opposed to independent drive tracks, a single drive unit may be used. Each drive unit 26a, 26b includes a motor 28 coupled to a planetary transmission hub 30 via an actuator 31, in this case, a solenoid valve controlled hydraulic clutch. Mechanical levers 29a, 29b control the traction drive pumps 24a, 24b to operate the drive motors 28 between neutral and forward and reverse drive. The left and right-hand actuators 31 are controlled by an operator input device 32 on the operator's console 34. The input device 32 provides an electrical signal indicative of the desired gear ratio. Preferably, a single device is utilized to send a common signal to both actuators 31 such that both transmissions 30 maintain the same gear ratio. While the illustrated vehicle is described with specific control levers, transmissions and actuators, other devices may also be used.

In the present invention, a transmission control system 100 is positioned in the path of the gear input signal between the input device 32 and the actuators 31. Preferably the control system 100 is self-contained such that it can be manufactured within a vehicle electrical system or spliced into the electrical system of an existing vehicle. Additionally, the self-contained system 100 can easily be removed from the electrical system, for example, for maintenance or replacement.

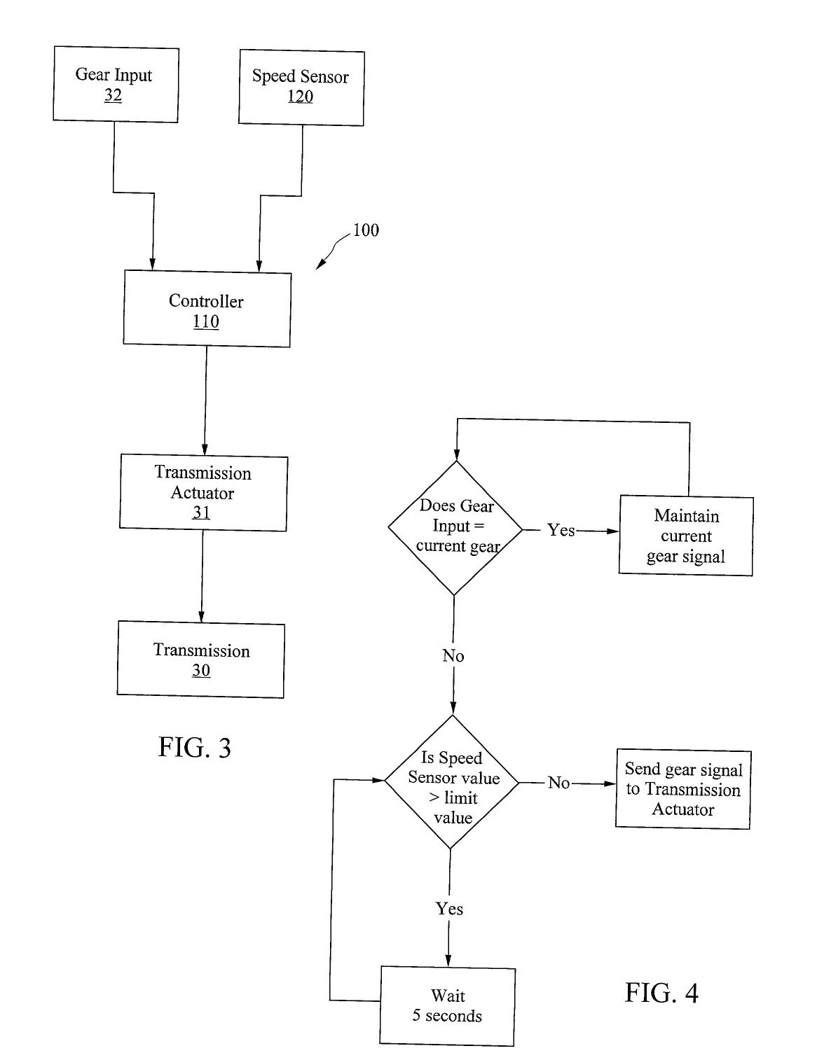

Referring to FIGS. 3 and 4, a first embodiment of the control system 100 is illustrated. In this embodiment, the control system 100 includes a controller 110 which receives input from the gear inputs 32 and from a vehicle speed sensor 120, for example, the vehicle's speedometer sensor. Based on the information received from the gear and speed inputs 32, 120, the controller 110 determines the appropriate gear signal to be sent to the transmission actuators 31 which in turn control the gear ratios of the transmissions 30.

The controller 110 determines the appropriate gear signal in accordance with the flow diagram illustrated in FIG. 4. The controller 110 continuously monitors the gear input and determines if it is equivalent to the current gear. If it is, the controller 110 maintains the current gear signal being sent to the actuators 31. As such, if the gear input is not changed, the controller 110 maintains a continuous loop of checking the input and maintaining the gear signal at the current value. If, on the other hand, the gear input is changed, the controller 110 then determines, based on the vehicle speed input 120, if the vehicle speed is above a limit value. It is preferred that the limit value equal zero, however, for different vehicles and different transmission arrangements, it may be acceptable to change gears at speeds greater than zero. For example, with the illustrated paver, it may be acceptable to change gears when the vehicle speed is 10 feet-per-minute or less. The limit speed can be set to meet the criteria of a given application.

If the vehicle speed is less than or equal to the limit value, the controller 110 sends the new gear input to the actuators 31 which in turn change the transmission gear ratios. If the vehicle speed is greater than the limit value, the controller 110 maintains the current gear signal being sent to the actuators 31, i.e., the controller 110 prevents a gear change while the vehicle speed is greater than the limit value. The controller 110 then waits a given amount of time, for example, 5 seconds, and again determines if the vehicle speed is greater than the limit value and repeats the control sequence as described above. It is intended that the operator will recognize that the gear ratio has not changed, and thereby will be alerted to slow the vehicle to a speed at or below the limit value. The control system 100 may also include an indicator (not shown), for example, a light or sound, which alerts the operator that the gear change is being prevented due to vehicle speed. Once the vehicle speed has been slowed to or below the limit speed, the controller 110 sends the new gear input to the actuators 31 which in turn change the transmission gear ratios as described above.

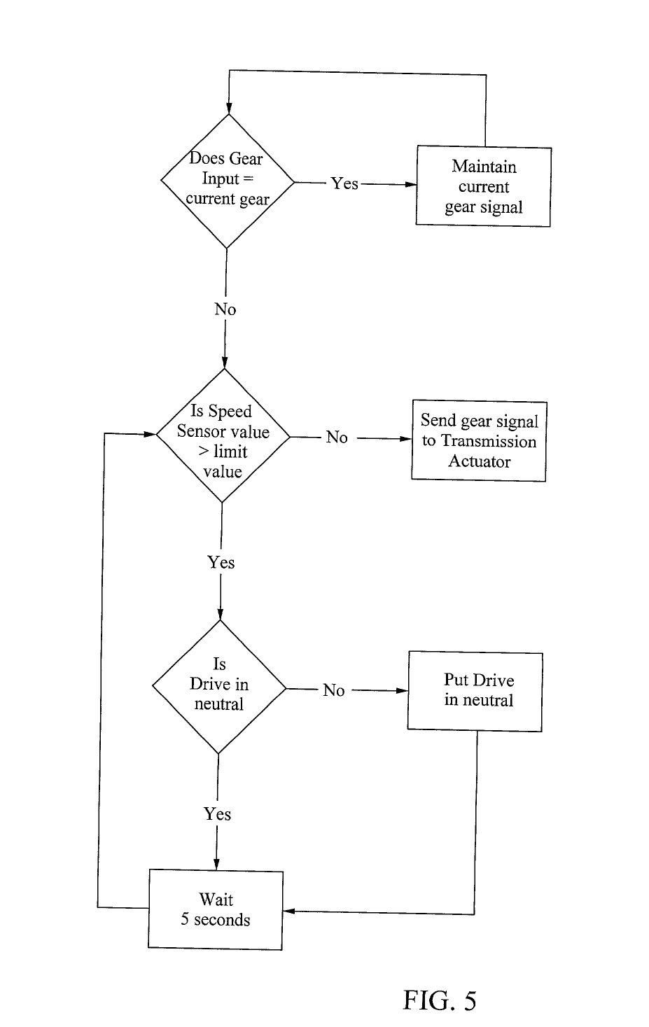

Referring to FIG. 5, an alternate control sequence is illustrated. In this sequence, if the speed is greater than the limit value, the controller 110 automatically places the vehicle drive into neutral to assist in slowing the vehicle and alerting the operator. If the vehicle has an electrically control drive mechanism, the controller 110 is configured to provide the drive mechanism with a neutral signal. If the drive mechanism is a mechanical system, as in the illustrated paver 10, the vehicle is provided with a mechanical shift override, an electro-mechanical device configured to receive a signal from the controller 110 and mechanically override the vehicle mechanical system to place the drive in neutral. After the drive is in neutral, the controller 110 will wait a predetermined amount of time and repeat the control sequence described above.

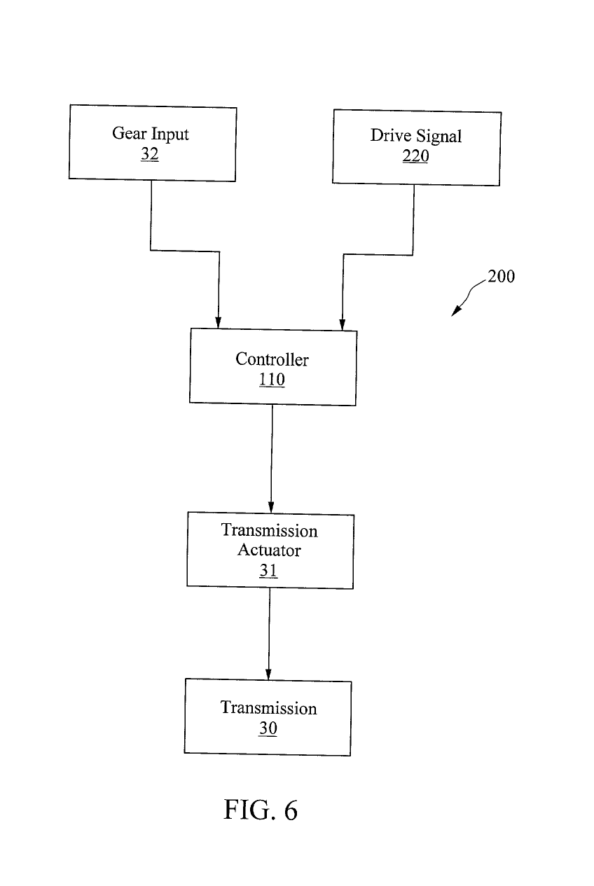

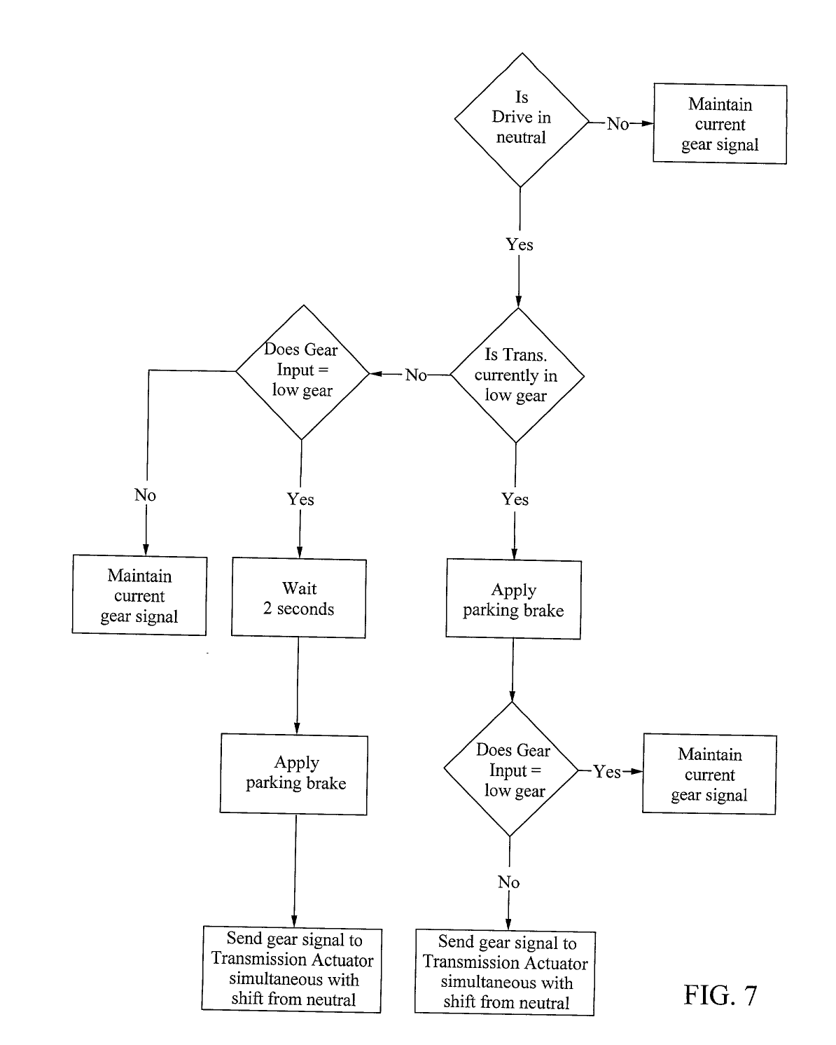

Referring to FIGS. 6 and 7, a second embodiment of the control system 200 is illustrated. The controller 110 receives input from the gear input 32 and a vehicle drive input 220. The vehicle drive input 220 is configured to signal the controller 110 whether the respective traction drive motors 28 are in neutral, or alternatively, are in forward or reverse drive. In the preferred embodiment, the specific drive direction is not material, only the distinction between neutral and a drive condition. Based on the information received from the gear and vehicle drive inputs 32, 220, the controller 110 determines the appropriate gear signal to be sent to the transmission actuators 31 which in turn control the gear ratios of the transmissions 30.

The controller 110 determines the appropriate gear signal in accordance with the flow diagram illustrated in FIG. 7. The controller 110 continuously monitors whether the drive motors 28 are in neutral. In the preferred embodiment, the drive signals for both motors are connected in series such that as either of the traction levers 29a, 29b is moved off of neutral, either forward or reverse, the signal from the vehicle drive input 220 drops from operating voltage, approximately 12 volts DC, to 0 volts DC. When the signal is 12 volts DC, the controller 110 recognizes both of the drive motors 28 are in neutral.

If the drive motors 28 are not in neutral, the controller 110 maintains the current gear signal being sent to the actuators 31 and disregards any new gear input signals, i.e., the controller 110 prevents a gear change when the motors are not in neutral. It is intended that the operator will recognize that the gear ratio has not changed, and will thereby be alerted to shift the vehicle drives to neutral. The control system 200 may also include an indicator (not shown), for example, a light or sound, which alerts the operator that the gear change is being prevented due to the vehicle drive. Once the vehicle drives have been placed in neutral, the controller 110 proceeds with the control sequence as described below.

Once a neutral signal is detected, the controller 110 determines if the transmissions 30 are currently operating in a “low”gear ratio, i.e., low speed, high torque. If the transmissions 30 are in a low gear ratio, the controller 110 sends a signal to apply the vehicle's parking brake. In the preferred embodiment, the vehicle parking brake is a function of the transmissions 30, that is, a brake signal causes the actuators 31 to produce a gear ratio which stops the drive track drive units 26a, 26b. However, the parking brake may also be configured to be independent of the transmission assembly. After the parking brake is applied, the controller 110 determines if a new gear ratio is selected by determining if the gear ratio input is equal to the current low gear operating condition or to a high gear ratio signal. If the gear ratio input signal is maintained at low while the vehicle is in neutral, the signal is not changed. If the gear ratio input signal is changed to high while the vehicle is in neutral, the controller 110 sends the new gear input to the actuators 31 which in turn change the transmission gear ratios. In the preferred embodiment in which the park brake is associated with the transmissions 30, the controller 110 awaits shifting of the drive from neutral and then, simultaneously therewith, sends the new gear ratio signal to the actuators 31, thereby avoiding premature deactivation of the parking brake. In embodiments wherein the parking brake is independent of the transmission signal, the signal can be sent immediately since it will not interfere with the parking brake.

If a neutral signal is received when the vehicle transmission is in a high gear, i.e. high speed, low torque, the controller 110 checks the gear input signal. If the gear input signal is a high gear signal, i.e., no change in gear, the controller 110 maintains the current gear signal. If the gear input signal is a low gear signal, i.e., a gear shift, the controller 110 waits a given amount of time, for example, 2 seconds, and then applies the parking brake. The delay helps prevent the paver from lurching to a halt from a high speed. After application of the parking brake, the new gear signal will be transmitted. Again, if the parking brake is associated with the transmissions, the controller 110 awaits a shifting from neutral before sending the new signal.

The automatic application of the parking brake is preferably included to prevent undesired rolling of the vehicle during working operation, for example, when the paver is paving. In the illustrated control sequence, the brake is not applied when the gear ratio is maintained in high gear since this is typically a travel gear condition as opposed to a working gear condition. If desired, the controller 110 can be configured to apply the brake in all conditions. Additionally, some vehicles have transmission ratios which are sufficient to independently prevent vehicle rolling when the motors are in neutral. In such cases, each of the “apply brake” steps of the control sequence can be eliminated.

Another feature of many industrial vehicles is a destroking of the traction pump when the vehicle brake is applied. This feature is intended to prevent an operator from trying to “drive through” the braking condition. The controller 110 of the present invention can be configured to override this destroking feature when the brake is automatically applied. Since the brake is only automatically applied when the drive motors are in neutral, the potential for “drive through” is eliminated, thereby eliminating the need for destroking. To override the destroke feature, the controller 110 sends a signal overriding the destroke signal to the mechanism controlling destroking of the pumps. Since the pumps are not destroked, they will not have to “spool up” when the drives are moved from neutral, but will instead by ready for immediate operation. This prevents the vehicle from coasting forward or backwards on grades while the pumps spool up.

It will be appreciated by those skilled in the art that changes can be made to the embodiments described above without departing from the broad inventive concept thereof. It is understood, therefore, that this invention is not limited to the particular embodiments disclosed, but it is intended to cover modifications within the spirit and scope of the present invention as generally and illustratively described herein.

What is claimed is:

1. A system for controlling gear shifting of an industrial vehicle having a transmission operable between at least two gear ratios by actuation of a transmission actuator in response to a gear ratio command, the system comprising:
a sensor configured to monitor one or more vehicle parameters; and
a controller associated with the sensor, the gear ratio command and the transmission actuator, the controller configured to prevent actuation of the transmission actuator unless one or more vehicle parameters is in a predetermined condition.

2. The system of claim 1 wherein the sensor monitors speed of the vehicle and the predetermined condition includes a vehicle speed less than or equal to a limit value.

3. The system of claim 2 wherein the limit value is equal to zero.

4. The system of claim 2 wherein the vehicle has a drive system operational between a neutral condition and at least one drive condition and the controller is configured to place the drive system in neutral if the one or more vehicle parameters are not in the predetermined condition.

5. The system of claim 1 wherein the vehicle has a drive system operational between a neutral condition and at least one drive condition wherein the sensor monitors the drive system condition and the predetermined condition includes a drive system neutral condition.

6. The system of claim 5 wherein the controller is further configured to apply a vehicle brake when the drive system neutral condition exists.

7. The system of claim 6 wherein the predetermined condition further includes application of the vehicle brake.

8. The system of claim 6 wherein the vehicle is driven by at least one traction pump cylinder and the vehicle is normally configured to destroke the cylinder upon application of the vehicle brake, the controller being further configured to prevent destroking of the cylinder when the vehicle brake is applied by the controller.

9. The system of claim 5 wherein the controller is further configured to apply a vehicle brake when the drive system neutral condition exists and the transmission is in a predetermined gear ratio.

10. The system of claim 9 wherein the predetermined gear ratio is a low gear ratio.

11. A system for controlling gear shifting of an industrial vehicle having a transmission operable between at least two gear ratios by actuation of a transmission actuator in response to a gear ratio command, the system comprising:
a sensor configured to monitor speed of the vehicle; and
a controller associated with the sensor, the gear ratio command and the transmission actuator, the controller configured to prevent transmission of the gear ratio command to the transmission actuator unless the vehicle speed is less than or equal to a limit value.

12. The system of claim 11 wherein the limit value is equal to zero.

13. The system of claim 11 wherein the vehicle has a drive system operational between a neutral condition and at least one drive condition and the controller is configured to place the drive system in neutral upon receipt of a new gear ratio command if the vehicle speed is greater than the limit value.

14. A system for controlling gear shifting of an industrial vehicle having a drive system operational between a neutral condition and at least one drive condition and a transmission operable between at least two gear ratios by actuation of a transmission actuator in response to a gear ratio command, the system comprising:
a sensor configured to monitor the drive system condition; and
a controller associated with the sensor, the gear ratio command and the transmission actuator, the controller configured to prevent actuation of the transmission actuator unless the drive system is in a neutral condition.

15. The system of claim 14 wherein the controller is further configured to apply a vehicle brake when the drive system neutral condition exists.

16. The system of claim 15 wherein the controller is further configured to prevent actuation of the transmission actuator unless the vehicle brake is applied.

17. The system of claim 16 wherein the vehicle is driven by at least one traction pump cylinder and the vehicle is normally configured to destroke the cylinder upon application of the vehicle brake, the controller being further configured to prevent destroking of the cylinder when the vehicle brake is applied by the controller.

18. The system of claim 14 wherein the controller is further configured to apply a vehicle brake when the drive system neutral condition exists and the transmission is in a predetermined gear ratio.

19. The system of claim 18 wherein the predetermined gear ratio is a low gear ratio.

20. A system for controlling gear shifting of a paver having a transmission operable between at least two gear ratios by actuation of a transmission actuator in response to a gear ratio command, the system comprising:
a sensor configured to monitor one or more parameters of the paver; and
a controller associated with the sensor, the gear ratio command and the transmission actuator, the controller configured to prevent actuation of the transmission actuator unless one or more paver parameters is in a predetermined condition.
